(19) United States
(12) Patent Application Publication
(10) Pub. No.: US 2005/0168448 A1
(43) Pub. Date: Aug. 4, 2005

(54) Interactive touch-screen using infrared illuminators

(76) Inventor: Zachary Booth Simpson, Austin, TX (US)

Correspondence Address: FORTKORT GRETHER + KELTON LLP, 8911 N. CAPITAL OF TEXAS HWY., SUITE 3200, AUSTIN, TX, 78759, US

(21) Appl. No.: 10/769,194

(22) Filed: Jan. 30, 2004

(51) Int. Cl. G09G 5/00

(52) U.S. Cl. 345/173

(57) ABSTRACT

Provided is a touch-screen system that employs infrared illuminators and detectors to determine where an object or person touches a translucent screen. A visual image is projected onto the translucent screen by means of a projector placed on the back side of the screen opposite the user. Infrared illuminators are placed on the front side of the translucent screen at oblique angles to the screen. When a user touches the screen each of the infrared illuminators is shadowed from the screen to a certain degree, depending upon the shape of the object placed upon the screen. By determining where on the screen the shadows cast by the object or person overlap, a computing device calculates where the object or person is touching the screen In an alternative embodiment, controlled ambient light rather than infrared illuminators is employed. Also provided is a calibration method for the system.

### TECHNICAL FIELD OF THE INVENTION

This invention pertains to a touch sensitive screen and, more particularly, to a touch screen that employs shadows cast by infrared illuminators and detected by a camera.

### BACKGROUND OF THE INVENTION

Touch-screen systems, which enable a user to initiate an action on a computing system by touching a display screen, have been available to consumers for a number of years. Typical touch-screen systems have three components a touch sensor, a controller and a software driver. A touch sensor consists of a clear glass panel with a touch responsive surface. The sensor may be built into a computer system or be an add-on unit. The touch sensor is placed over a standard computer display such that the display is visible through the touch sensor. When a user makes contact with the touch sensor, either with a finger or a pointing instrument, an electrical current or signal that passes through the touch sensor experiences a voltage or signal change. This voltage or signal change is used to determine the specific location on the touch sensor where the user has made contact.

The controller takes information from the touch sensor and translates that information into a form that the computing system to which the touch-screen is attached understands. Typically, controllers are attached to the computing system via cables or wires. The software driver enables the computing system's operating system to interpret the information sent from the controller.

Often, touch-screen systems are based upon a mouse-emulation model; i.e. touching the screen at a particular location is interpreted as though there has been a mouse click at that location. For example, multiple choices, such as restaurant menu options, are displayed on a computer screen and a user, by touching the touch sensor at the location on the screen where a desired option is displayed, is able to select the particular option.

There are also infrared touch-screen systems that employ an array of infrared illuminators, each of which transmit a narrow beam of infrared light to a spot on the screen. An array of detectors, corresponding to an array of infrared illuminators, determines the location of a touch on a screen by observing which of the narrow beams have been broken. This type of system suffers from low resolution and an inability to accurately scale up to larger screens.

### SUMMARY OF THE INVENTION

The claimed subject matter is a novel touch-screen that employs infrared illuminators and detector to determine where an object or person touches a translucent screen. A visual image is projected onto the translucent screen by means of a projector placed on the side of the screen opposite the user, or the “back” side. The visual image provides information such as, but not limited to, feedback in an interactive system or a number of available options in some type of produce ordering system. Infrared illuminators are placed on the front side of the translucent screen at oblique angles to the screen. When a user touches the screen each of the infrared illuminators is shadowed from the screen to a certain degree, depending upon the shape of the object placed upon the screen. In other words, an object in the path of the infrared illuminators casts a shadow on the screen

One or more infrared detectors or camera are mounted to the rear of the screen such that the detectors can sense the shadows cast by the object or person. By determining where on the screen the shadows cast by the object or person overlap, a computing device calculates where the object or person is touching the screen. The exact position and shape of the point of contact on the screen can be determined by filtering the darkest regions on the screen in the infrared wavelengths. Although described in conjunction with infrared illuminators and projectors, the claimed subject matter can be applied in any frequencies in which illuminators and corresponding projectors exist. In an alternative embodiment, controlled ambient light rather than illuminators is employed.

Infrared illuminators are described because infrared light is not visible to humans and the illuminators therefore do not interfere with the visual images created by the projector. The claimed subject matter accurately determines location of a touch in such a touch-screen system and has the advantage of being extremely scalable, with the ultimate size limited only by the brightness of the illuminators. In addition, the system can be assembled with readily available parts and can be installed without precise alignment on any rear-projection screen.

Another aspect of the claimed subject matter is a calibration performed on the system so that precise alignment of the components is not required. Calibration can be performed using the visible light spectrum. In one embodiment of the invention, information extracted from a visual camera is sampled by a computer and used to control a projected user interface such that the user is able to control images on the screen. User control may include such actions as manipulating controls, creating drawings and writing.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 illustrates an exemplary touch-screen system employing the claimed subject matter.

FIG. 2 is a rear view of the translucent screen illustrated in FIG. 1.

FIG. 3 is graph of a filtering function employed in conjunction with the claimed subject matter.

FIG. 4 is an image of from the rear view of the screen of FIG. 1 after the filtering function of FIG. 3 has been applied.

FIG. 5 illustrates the touch-screen system of FIG. 1 during a “Setup/Calibration” process described in conjunction with FIGS. 7-9.

FIG. 6 illustrates a view from the camera of FIG. 1 during the Setup/Calibration process described in conjunction with FIGS. 7-9.

FIG. 7 is a flowchart of a Setup/Calibration process for the touch-screen system of FIG. 1.

FIG. 8 is a flowchart of a “Create Camera Mask” step of the Setup/Calibration process illustrated in FIG. 7.

FIG. 9 is a flowchart of a “Create Brightness Mask” step of the Setup/Calibration process illustrated in FIG. 7.

FIG. 10 is a flowchart of an operational process for the touch-screen system of FIG. 1.

### DETAILED DESCRIPTION OF THE FIGURES

In the following description, numerous details are set forth to provide a through understanding of the claimed subject matter. Well-known components, such as, but not limited to, cameras, projectors and computers are illustrated in block diagram form in order to prevent unnecessary detail. In addition, detailed algorithm implementations, specific positional and lighting levels and other such considerations have been omitted because such details are not necessary for an understanding of the claimed subject matter and are within the skills of a person with knowledge of the relevant art. Throughout the detailed description infrared light is used as an example, although the claimed subject matter is equally applicable to other types of non-visible light or other radiation.

In addition, various techniques of the present invention can be implemented in software, hardware, or a combination of software and hardware. The hardware portion can be implemented using specialized logic; the software portion can be stored in a memory and executed by a suitable instruction execution system such as a microprocessor.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and/or recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

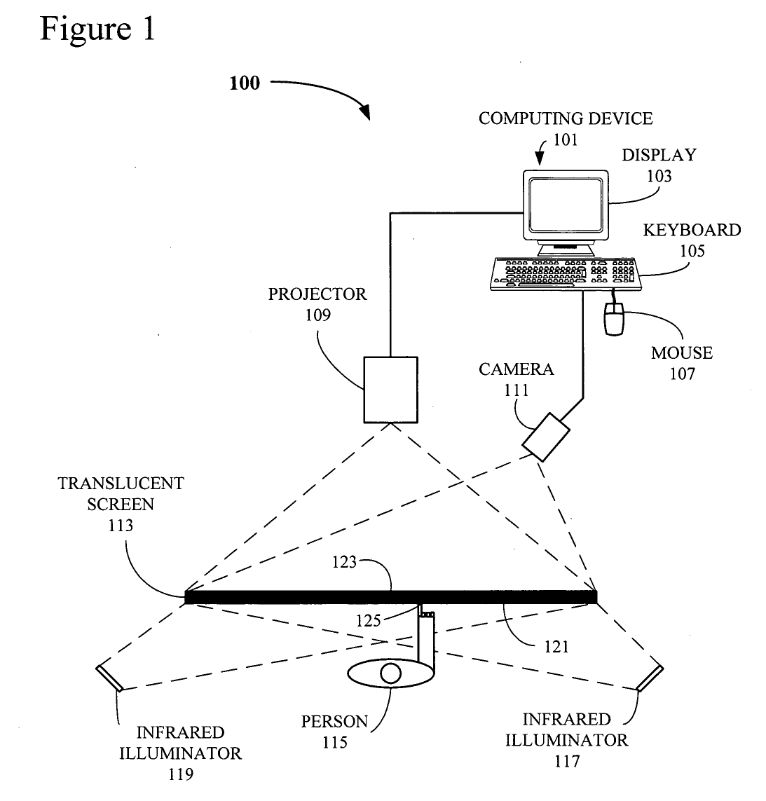

FIG. 1 illustrates an exemplary touch-screen system 100 employing the claimed subject matter. A translucent screen 113 is placed so that images can be projected onto screen 113 from a back, or rear, side 123 by a projector 109. A user, or person, 115 is positioned on a front side 121 of screen 113, facing screen 113 and, in this example, touching front side 121 at a point 125. User 115 sees images projected onto screen 113 by projector 109, which is, in this example, driven by a computing device 101. Although there are many suitable alternatives, computing device 101 is a personal computer (PC) that includes a display 103, a keyboard 105 and a pointing device, or mouse, 107. Display 103, keyboard 105 and mouse 107, all of which should be familiar to those with skill in the computing arts, provide a means of interacting with PC 101.

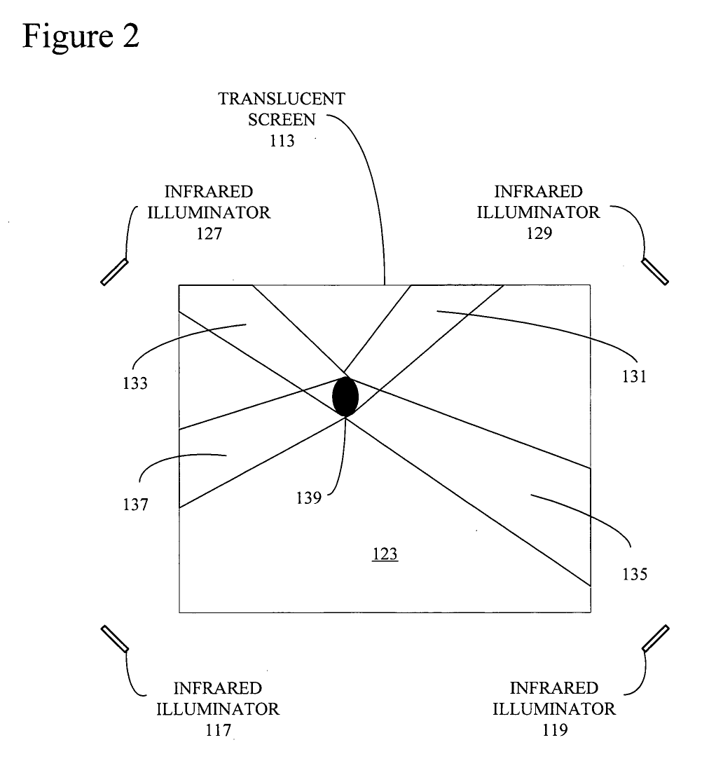

Two infrared illuminators 117 and 119 are positioned on front side 121 of screen 113 such their emitted light is an oblique angle to screen 113. In this manner, infrared light emitted by illuminators 117 and 119 falls on translucent screen 113 and is visible to an infrared sensitive camera 111 positioned on back side 123 of screen 113. When user 115 touches screen 113, illuminators 117 and 119 cast infrared shadows visible to camera 111 (see FIG. 2).

In an alternative embodiment of system 100, ambient infrared light is employed rather than light produced by illuminators such as illuminators 117 and 119. In this embodiment, an opaque screen or wall (not shown) is positioned behind user 115 so that the ambient light strikes screen 113 at oblique angles. In this manner, shadows produced by the ambient light are utilized to practice the claimed subject matter as explained below in conjunction with FIGS. 2-10.

FIG. 2 is a view of back side 123 of translucent screen 113 illustrated in FIG. 1, including two additional infrared illuminators 127 and 129, which are not visible in FIG. 1 and are positioned in a similar fashion to illuminators 117 and 119. When user 115, who is not visible because he/she is positioned on front side 121 of screen 113, touches screen 113 at point 125, illuminators 117, 119, 127 and 129 cast shadows 131, 133, 135 and 137, respectively. In an area 139, corresponding to point of contact 125, shadows 131, 133, 135 and 137 converge, creating a dark spot that is detected by camera 111.

Camera 111, in conjunction with PC 101, detects area 139 and thus determines where user 115 is touching screen 113. It should be noted that, although this example employs a simple geometric figure as touch point 125, the present invention is equally capable of detecting more complex shapes such as, but not limited to, a human hand in contact with screen 113. In addition, a single illuminator, such as one of illuminators 117, 119, 127 and 129, is able to provide enough information to determine a single point of contact. In other words, a single, non-complex touch point, such as touch point 125 can be calculated by PC 101 using a single illuminator by making assumptions about the size and shape of the particular contact.

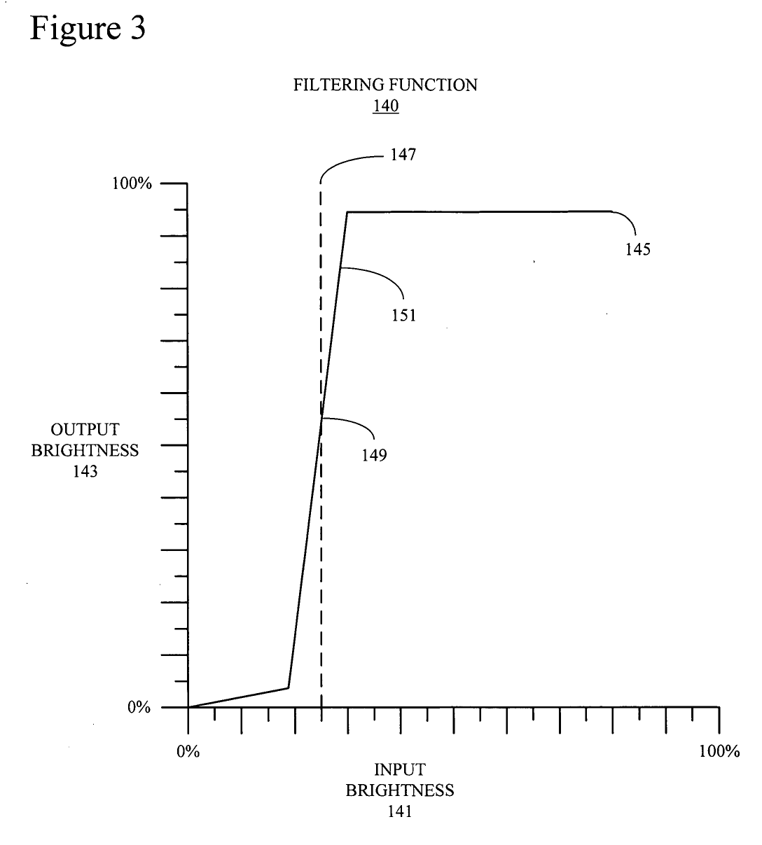

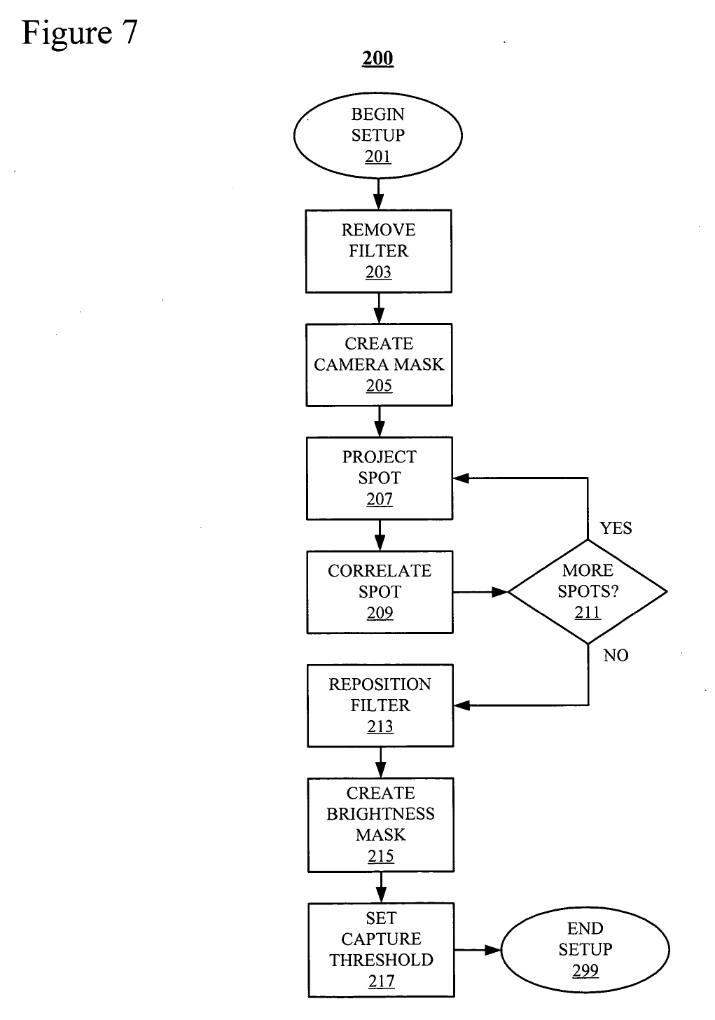

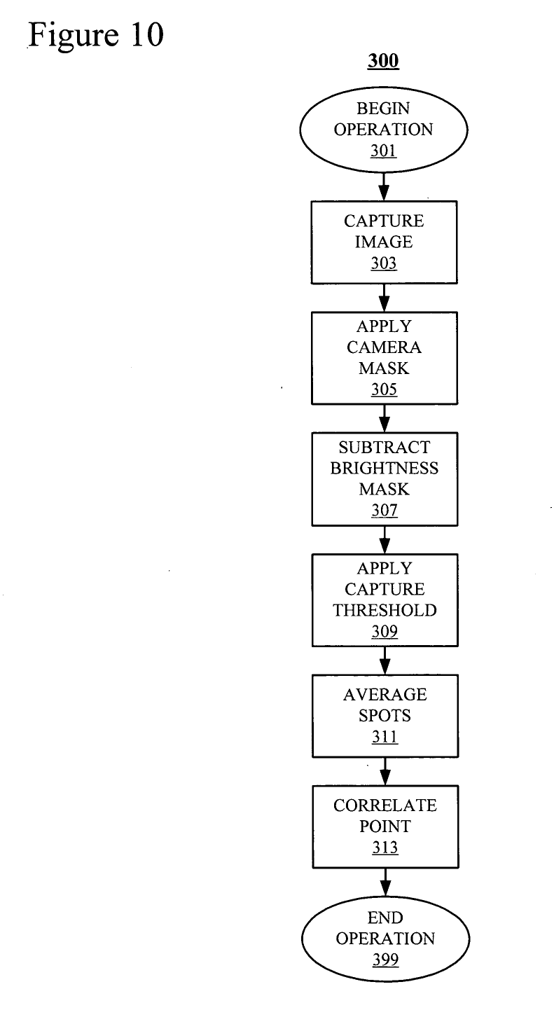

FIG. 3 is graph 140 of a filtering function employed in conjunction with the claimed subject matter that converts a gray-scale image into black and white mask. Filtering functions such as function 140 are employed in system 100 (FIG. 1) to perform tasks such as creating a mask to filter out portions of an image captured by camera 111 (FIG. 1) that are unnecessary for processing and for identifying point of contact 139 (FIG. 2). The use of filtering function 140 is described in more detail below in conjunction with a Calibration process 200 (see FIGS. 7-9) and an Operation process 300 (see FIG. 10).

Input brightness 141 is plotted against output brightness 143, with some exemplary measurements from system 100 showing up as a plot 145. A threshold value 147 is selected so that only the darkest regions of a video image coming into camera 111 (FIGS. 1 and 2) are determined to represent either a point of contact to screen 113 (FIGS. 1 and 2) or a region of a captured image that requires processing. For example, threshold 147 intersects plot 145 at a point 149, which represents a relatively dark point on screen 113 with an input brightness 141 equal to a value of twenty-five percent (25%). Values to the left of point 149, i.e. those points with an input brightness value less than 25% represent points of contact on screen 113. Points either on or to the left of threshold 147 are set to an output brightness 143 close to a value of zero percent (0%).

Points on plot 145, such as an exemplary point 151, to the right of point 149 represent areas on screen 113 where it is not dark enough to exceed thresholds 147 and therefore does not represent a point of contact. In fact, point 151 may represent a point within one of shadows 131, 133, 135 and 137 (FIG. 2) that does not also fall within region 139 (FIG. 2).

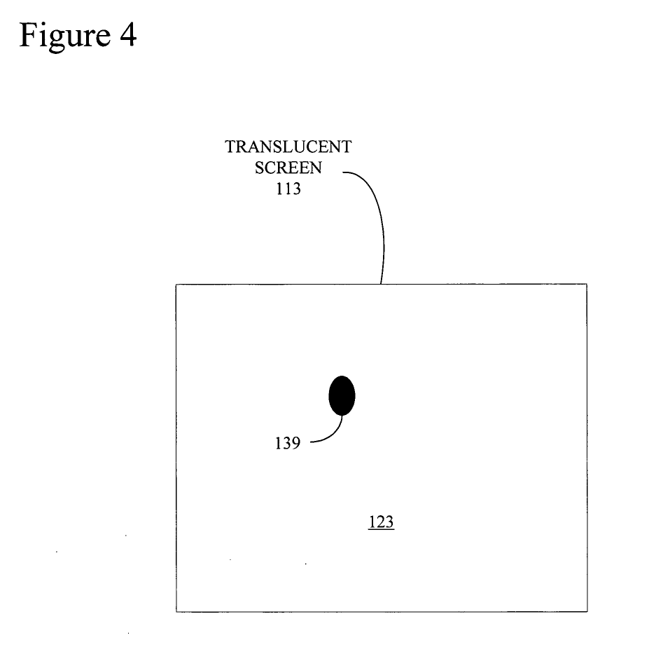

Threshold 147 is chosen such that only the darkest areas displayed on screen 113 are allowed to pass filtering function 140 (see FIG. 4). An exact value for threshold 147 is installation specific and may change as light levels change, perhaps even during a particular installation. Filtering function 140 can be expressed mathematically as a function f(x,y) where (x,y) represents the coordinate of a point in the camera image . In that case, function 140 can be expressed as f(x,y)=0 if camera(x,y)<20%; otherwise f(x,y)=1.

Filtering function 140 is typically implemented as a software algorithm running on computing system 101, which is attached to camera 111 (FIG. 1). However, filtering function 140 may also be built into hardware, or some combination of hardware and software, specifically designed for the task.

FIG. 4 is rear view 123 of the screen of FIG. 1 after filtering function 140 of FIG. 3 has been applied to screen 113 as it appears in FIG. 2. Translucent screen 113 now only has region 139 displayed because non-overlapping areas of shadows 131, 133, 135 and 137 have been filtered out. Thus, system 100 determines where user 115 is actually touching screen 113 rather than merely close to screen 113. As mentioned above in conjunction with FIG. 3, this example illustrates a simple shape 139 but the method of the claimed subject matter is able to render more complex shapes that com into contact with screen 113. For the sake of simplicity, the illuminators 117, 119, 127 and 129 of FIG. 2 are not shown.

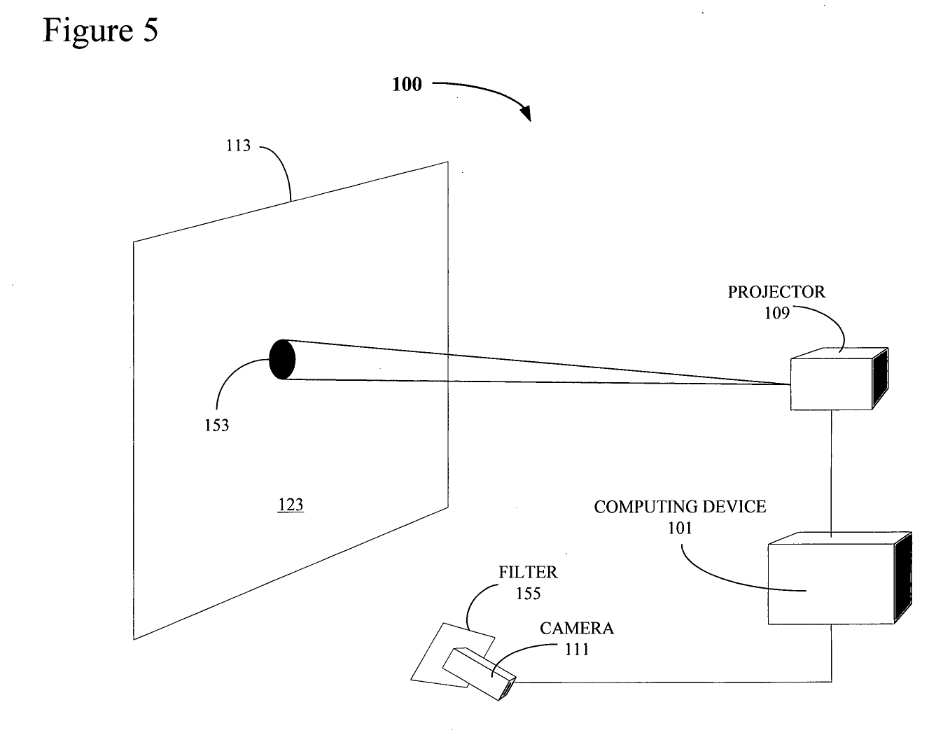

FIG. 5 illustrates touch-screen system 100 of FIG. 1 during a Setup/Calibration process 200 described in detail below in conjunction with FIG. 7. Projector 109, computing device 101, camera 111 and translucent screen 113 are illustrated from back view 123, from a slightly different perspective than in FIG. 1. In this example, computing device 101 directs projector 109 to project a spot 153 onto back view 123 of screen 113. Camera 111, also coupled to computing device 101. In this example, a filter 155 is installed between camera 111 and screen 113. In the disclosed embodiment, filter 155 allows infrared light to pass but blocks the visible light spectrum.

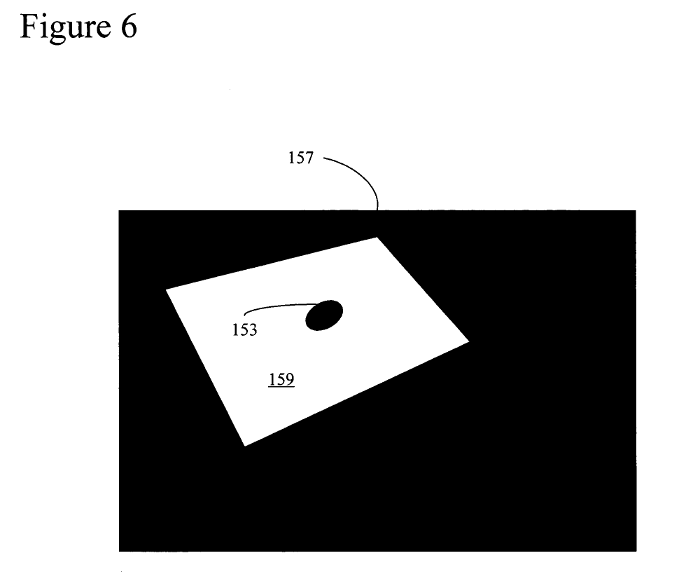

FIG. 6 illustrates a camera view 157 from camera 111 (FIGS. 1 and 5) during Setup/Calibration process 200 described in below in conjunction with FIG. 7. Throughout the remainder of this Specification, Camera view 157 is also referred to as “camera space” 157. To camera 111, translucent screen 113 appears as an image space 159. Within image space 159, calibration spot 153 (FIG. 5) is illustrated. It should be noted that the boundaries of image space 159 are typically not straight lines, as shown here, but rather arcs due to camera distortion.

FIG. 7 is a flowchart of Setup/Calibration process 200 for touch-screen system 100 (FIG. 1). Setup/Calibration process 200 begins in a “Begin Setup” step 201 and control proceeds immediately to a “Remove Filter” step 203 in which filter 155 (FIG. 5) is removed from the from of camera 111 (FIGS. 1 and 5). The removal of filter 155 enables system 100 to be calibrated using visible light. During this portion of Setup/Calibration process 200, illuminators 117, 119, 127 and 129 (FIGS. 1 and 2) are turned off.

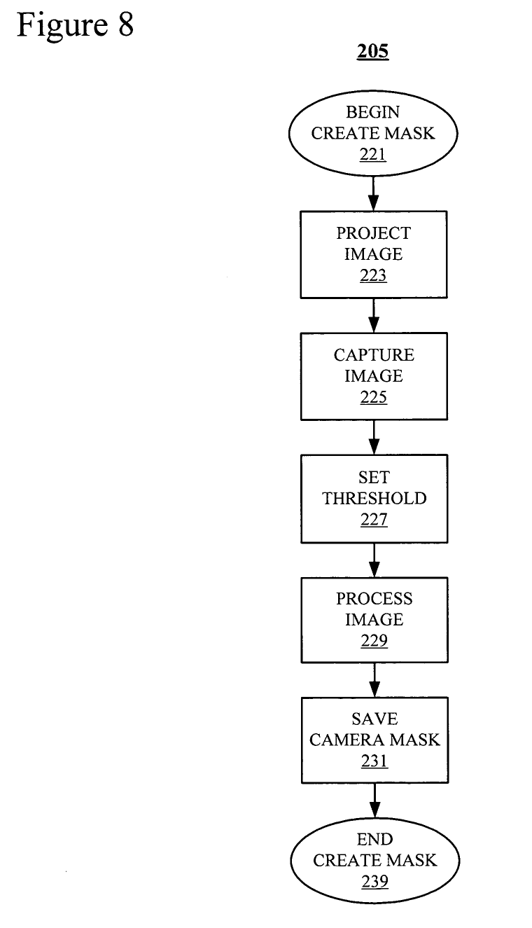

From step 203 control proceeds to a “Create Camera Mask” step 205, which is described in more detail below in conjunction with FIG. 8. In short, during step 205, system 100 creates a camera mask that enables system 100 to separate subsequent images into camera space 157 (FIG. 6) and image space 159 (FIG. 6). During subsequent image processing, computing system 101 (FIG. 1) separates image space 159 from camera space 157 in order to process only those pixels that are relevant to system 100 by ignoring those pixels in camera space 157 that are outside image space 159.

Control then proceeds to a “Project Spot” step 207. The “spot” being processed in step 207 is exemplified by spot 153, which is shown in FIG. 5 as displayed on translucent screen 113 and in FIG. 6 as viewed in image space 159 of camera 111. Spot 153 is projected onto screen 113 (FIGS. 1, 2, 4 and 5) by projector 109 (FIGS. 1 and 5) around a known set of coordinates. Control then proceeds to a “Correlate Spot” step 209 in which computing system 101 calculates the coordinates of spot 153 in image space 159. The particular coordinates of spot 153 are determined by calculating an average location for spot 153 as it appears in image space 159. The known coordinates and the calculated coordinates are then stored by computing system 101 as a “calibration coordinate pair.”

Control then proceeds to a “More Spots?” step 211 in which process 200 determines whether or not enough spots have been processed to complete Setup/Calibration process 200. This determination is a judgment call based upon such factors as the desired resolution of the system. During each iteration through steps 207, 209 and 211 a new spot is processed, with each new spot determined by shifting the coordinates of the current spot by some finite amount. In one embodiment, spots representing a large number of points in translucent screen 113, and thereby image space 159, are processed. In another embodiment, only a few sample points are used for calibration. In either scenario, the ultimate processing of a particular point on translucent screen 113 involves either extrapolation from known, calibrated spots or on curve matching, both based upon the calibration coordinate pairs created in step 209. If process 200 determines in step 211 that more spots need to be used in the calibration, then control returns to Project Spot step 207, in which another spot is projected and processed as described above.

If, in step 211, process 200 determines that enough spots have been processed, control proceeds to “Reposition Filter” step 213 in which filter 155 (FIG. 5), removed in “Remove Filter” step 203, is replaced for normal operation (see FIG. 10) of system 100. With filter 155 in place, camera 111 (FIGS. 1 and 5) detects light in the spectrum of illuminators 117, 119, 127 and 129 and does not detect visible light.

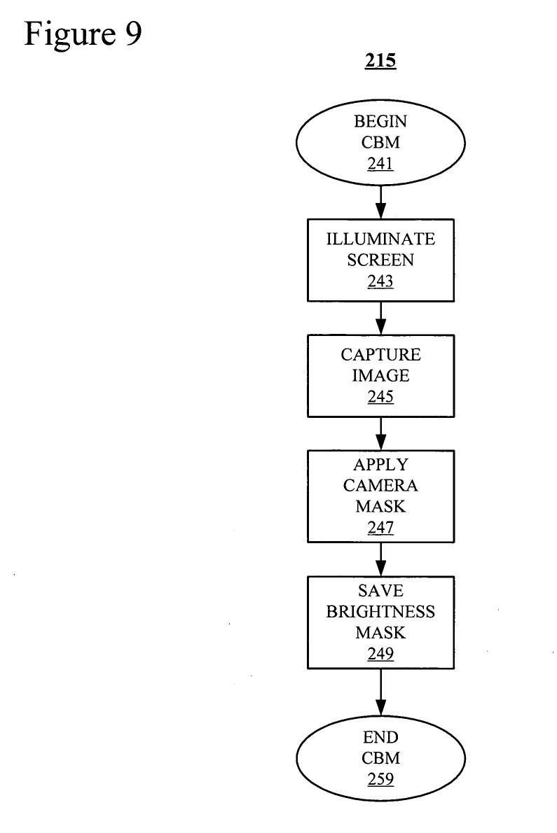

Control then proceeds to a “Create Brightness Mask” step 215, which is described in more detail below in conjunction with FIG. 9. In short, the brightness mask created in step 215 is employed to account for differences in brightness between different portions of screen 113 (see FIG. 10). It should be noted that during step 215 illuminators 117, 119, 127 and 129 are turned back on. Control then proceeds to a “Set Capture Threshold” step 217 in which a threshold, similar to threshold 147 (FIG. 3) is set for operation processing (see FIG. 10). Finally, control proceeds to an “End Setup” step in which Setup/Calibration process 200 is complete.

FIG. 8 is a flowchart that shows Create Camera Mask step 205 of FIG. 7 in more detail. Processing begins in a “Begin Create Mask” step 221 and control proceeds immediately to a “Project Image” step 223 in which projector 109 (FIGS. 1 and 5) projects a full image in the visible spectrum onto translucent screen 113. Control then proceeds to a “Capture Image Step” 225 in which the resultant, or “calibration,” image is captured by camera 111, i.e. image space 159 (FIG. 6) is displayed in camera space 157 (FIG. 6), illuminated by visible light, without calibration spot 153. Next, a threshold is set in a “Set Threshold” step 227. This threshold is determined by selecting a brightness value such that pixels in image space 159 exceed the threshold value but pixels in camera space 157 that are not in image space 159 do not.

Control then proceeds to a “Process Image” step 229 in which the calibration image of camera space 157, captured in step 225, is processed by computing system 101 (FIG. 1), pixel-by-pixel. This processing involves looking at each pixel in turn and determining whether the brightness value of the pixel exceeds the threshold set in step 227. If so, then the value of the pixel in the calibration image is set to a value equal to ‘1’, otherwise the value is set to a value equal to “0’. Control then proceeds to a “Save Camera Mask” step in which the modified calibration image is stored in memory (not shown) of computing system 101 as a camera mask. Finally, control proceeds to an “End Create Mask” step 239 in which step 205 is complete. In this manner, a camera mask is created that enables computing system 101 to process, in subsequent captured images, only those pixels that lie within image space 159 and to ignore those pixels that lie outside image space 159.

FIG. 9 is a flowchart that shows Create Brightness Make (CBM) step 215 of FIG. 7 in more detail. Processing begins in a “Begin CBM” step 241 and control proceeds immediately to an “Illuminate Screen” step 243 in which illuminators 117, 119, 127 and 129 (FIGS. 1 and 2) are turned on and translucent screen 113 (FIGS. 1, 2, 4 and 5) is illuminated in the infrared spectrum. Control then proceeds to a “Capture Image” step 245 in which camera 111 (FIGS. 1 and 5) captures an image of translucent screen 113 and transmits the image to computing system 101 (FIG. 1) for processing. Next, in an “Apply Camera Mask” step 247, the camera mask created in Create Camera Mask step 205 (FIGS. 7 and 8) is employed to eliminate, i.e. set pixel values equal to ‘1’) the portions of the image captured in step 245 that do not correspond to image space 159 (FIG. 6).

Control then proceeds to a “Save Brightness Mask” step 249 in which the modified, captured image is stored in memory of computing system 101 as a brightness mask This brightness mask provides a baseline for the relative brightness of screen 113 when screen 113 is fully illuminated by illuminators 117, 119, 127 and 129. The brightness mask is employed during operational processing 300 described below in conjunction with FIG. 10. Finally, in an “End CBM” step 259, step 215 is complete.

FIG. 10 is a flowchart of Operation process 300 that is employed during the operational running of system 100 (FIG. 1). Process 300 starts in a “Begin Operation” step 301 and control proceeds immediately to a “Capture Image” step 303 in which camera 111 (FIGS. 1 and 5) reads a gray-scale image and transmits the image to computing system 101 (FIG. 1). Control then proceeds to an “Apply Camera Mask” step 305 in which the camera mask created in step 205 (FIGS. 7 and 8) is applied to the image captured in step 303 in order to filter out those portions of the image that do not represent image space 159 (FIG. 6).

Control then proceeds to a “Subtract Brightness Mask” step 307 in which the brightness mask create in step 215 (FIGS. 7 and 9) is employed to adjust the image capture in step 303 based upon the relative brightness of various portions of screen 113 (FIGS. 1, 2, 4 and 5). Control then proceeds to an “Apply Capture Threshold” step 309 in which the threshold set in step 217 (FIG. 7) is applied to the captured image in order to isolate a point or points of contact 139 (FIG. 4). Once the one or more points of contact are determined in step 309, then control proceeds to an “Average Spots” step 311 in which a single point coordinate is calculated for each spot 139 based upon an average value for all the pixels within each corresponding spot. Step 311 is omitted if information about the shape of contact area 139 is desired. For example, if used to identify a GUI control, a user probably needs to identify a single point of contact associated with area 139. If a user wants to process the actual shape of contact area 139, such as to determine that are 139 is a hand print, then the entire area 139 is plotted rather than averaged.

Control then proceeds to a “Correlate Points” step 313 in which each coordinate point associated with each isolated spot is matched with a coordinate in Screen space 157 based upon the calibration coordinate pairs generated and stored in Setup/Calibration process 200 (FIG. 7). As mentioned above, the calibration coordinate pairs can be read from a lookup table and a screen coordinate calculated from an extrapolation of known values or the calibration coordinate pairs can be used to generate a function into which the coordinates generated in step 313 are entered in order to calculate corresponding coordinates in screen space 157. Finally, control proceeds to an “End Operation” step 399 in which Operation process 300 is complete.

It should be understood that Operation process 300 executes over and over while system 100 is in operation mode, as opposed to Setup/Calibration mode 200. In other words computing system 101 is executing process 300 either periodically or every time the image from camera 111 changes. Once a set of coordinates is determined in Operation mode 300, there are a number of ways to use the coordinates, depending upon the particular application running on computing system 101. For example, the calculated coordinates may be used in conjunction with a GUI to simulate input from a mouse 107 (FIG. 1). Graphical applications may use the coordinates to provide feedback in the form of writing or graphics. The claimed subject matter provides a way to detect the size, shape and location of a particular contact with a screen 113—the uses to which this capability can be employed are limited only by the imagination.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A touch-screen system, comprising:
a computing system;
a translucent screen;
a plurality of illuminators that project in a particular range of frequencies, wherein the plurality of illuminators are configured such that an object touching the translucent screen casts a plurality of shadows, each shadow corresponding to an illuminator of the plurality of illuminators; and
a camera sensitive to the particular range of frequencies to which the plurality of illuminators is sensitive;
wherein a first image captured by the camera is employed by the computing system to determine where the object touches the translucent screen based upon the locations of the plurality of shadows in the first image.

2. The touch-screen system of claim 1, further comprising:
a brightness threshold filter for extracting areas of the first image corresponding to a junction of the plurality of shadows.

3. The touch-screen system of claim 1, wherein the particular range of frequencies are non-visible.

4. The touch-screen system of claim 3, wherein the non-visible range of frequencies are in the infrared portion of the spectrum.

5. The touch-screen system of claim 1, further comprising a projector that projects a graphical user interface (GUI) onto the translucent screen, wherein the GUI is actuated based upon the determination of where the object touches the translucent screen.

6. The touch-screen system of claim 5, wherein the determination of where the object touches the translucent screen is employed to emulate actions of a mouse device.

7. The touch-screen system of claim 1, further comprising a projector that projects a second image onto the translucent screen, wherein the second image provides visual feedback based upon the determination of where the object touches the translucent screen.

8. The touch-screen system of claim 7, wherein the visual feedback is writing corresponding to where the object touches the screen.

9. The touch-screen system of claim 1, further comprising a projector, wherein the touch-screen system is calibrated by projecting a series of registration images from the projector at known coordinates onto the translucent screen, each of the series of registration images being captured by the camera and correlated to the corresponding registration image to create a coordinate pair.

10. A touch-screen system, comprising:
a computing system;
a translucent screen;
a barrier, opaque to ambient light and positioned such that ambient light strikes the translucent screen only at oblique angles; and
a camera sensitive to a range of frequencies associated with the ambient light;
wherein a first image captured by the camera is employed by the computing system to determine where an object touches the translucent screen based upon a plurality of shadows cast by the object in conjunction with the ambient light.

11. The touch-screen system of claim 10, further comprising:
a threshold filter for extracting areas of the first image corresponding to the plurality of shadows.

12. The touch-screen system of claim 10, wherein the ambient light is in the infrared portion of the spectrum.

13. The touch-screen system of claim 10, further comprising a projector that projects a graphical user interface (GUI) onto the translucent screen, wherein the GUI is actuated based upon the determination of where the object touches the translucent screen.

14. The touch-screen system of claim 13, wherein the determination of where the object touches the translucent screen is employed to emulates actions of a mouse device.

15. The touch-screen system of claim 10, further comprising a projector that projects a second image onto the translucent screen, wherein the second image provides visual feedback based upon the determination of where the object touches the translucent screen.

16. A method of calculating coordinates of an area of contact on a touch-screen, comprising the steps of:
illuminating a translucent screen such that an object that touches the translucent screen cast one or more shadows on the translucent screen;
detecting the one or more shadows to create a first image of the translucent screen; and
calculating an area of contact upon the translucent screen corresponding to where the object touches the translucent screen based upon the first image.

17. The method for claim 16, further comprising the steps of:
filtering the first image with respect to a brightness threshold to produce a modified image with increased contrast; and
executing the calculation step based upon the modified image rather than the first image.

18. The method of claim 16, wherein the illumination step is accomplished by one or more illuminators that illuminate in a non-visible spectrum.

19. The method of claim 18, wherein the non-visible spectrum is in the infrared spectrum.

20. The method of claim 16, further comprising the step of projecting a second image onto the translucent screen, wherein the second image provides visual feedback on the translucent screen based upon the calculation of where the object touches the translucent screen.

21. The method of claim 20, wherein the visual feedback is writing corresponding to where the object touches the screen.

22. The method of claim 16, further comprising the steps of:
projecting a graphical user interface onto the translucent screen;
calculating an average value for area of contact;
associating the average value with a point on the translucent screen; and
actuating the GUI based upon the point.

23. The method of claim 22, further comprising the step of emulating a computer mouse based upon the point.

24. A method of calibrating a touch-screen, comprising the steps of:
projecting onto a translucent screen a series of registration spots, each of the registration spots projected to a known coordinate on the translucent screen;
capturing a series of images of the translucent screen, each image corresponding to one spot of the series of projected spots;
calculating a coordinate in each image of the series of images corresponding to the corresponding projected spot;
correlating the known coordinate of each of the registration images to the calculated coordinate to create a coordinate pair; and
saving the coordinate pairs corresponding to each spot.
